(19) United States
(12) Patent Application Publication
(10) Pub. No.: US 2026/0068815 A1
(43) Pub. Date: Mar. 12, 2026

(54) Operator Assistance System

(71) Applicant: AGCO International GmbH, Neuhausen (CH)

(72) Inventors: Martin Peter Christiansen, Randers (DK); Esma Mujkic, Randers (DK); Morten Leth Bilde, Langaa (DK); Morten Stigaard Laursen, Randers (DK); Kenneth Düring Jensen, Randers (DK)

(21) Appl. No.: 19/108,943

(22) PCT Filed: Sep. 8, 2023
(86) PCT No.: PCT/IB2023/058909

§ 371 Date: Mar. 5, 2025

(30) Foreign Application Priority Data
Sep. 23, 2022 (GB) 2213881.2

(51) Int. Cl. A01D 41/127; B60K 35/22; B60K 35/28

(52) U.S. Cl. CPC A01D 41/127; B60K 35/22; B60K 35/28

(57) ABSTRACT

Methods and systems are provided for controlling operation of an operator assistance system for an agricultural machine. Image data is received from each of a plurality of imaging sensors associated with the agricultural machine, which is analysed to determine, for each sensor, an identity for a common object within respective imaging regions of the imaging sensors. The determined identities from each of the sensors are used to determine a configuration for a user interface of the operator assistance system.

### CROSS-REFERENCE TO RELATED APPLICATIONS

Not applicable.

### FIELD

Embodiments of the present disclosure relate generally to an operator assistance system for an agricultural machine, and in particular for an operator assistance system incorporating multiple imaging sensors.

### BACKGROUND

Operator assistance systems for agricultural machines take a number of forms. In some instances, this can include incorporation of sensing technology onto the machine to provide additional information to an operator. This can include, for example, cameras or the like positioned about the machine to provide additional views to an operator. Other technologies may include LIDAR sensors or the like which advantageously provide information relating to depth in the image, e.g. distance to objects, etc.

Operating conditions can vary greatly during and between different agricultural operations. It is therefore beneficial to be able to provide an assistance system where the sensing technology can operate across many of these conditions. However, due to the nature of some of the sensors available this may not be possible. For instance, use of a camera such as an RGB or greyscale camera in low light conditions, such as at dusk or night may not provide sufficient or useful information to an operator.

It would therefore be advantageous to provide an operator assistance system for an agricultural machine which incorporates multiple imaging systems for assisting the operator in multiple different operating conditions.

### BRIEF SUMMARY

An aspect of the invention provides a control system for an operator assistance system for an agricultural machine, the control system comprising one or more controllers, and being configured to: receive image data from each of a plurality of imaging sensors associated with the agricultural machine, the imaging sensors being configured to image respective imaging regions which at least partly overlap; analyse the image data from each sensor to determine, for each sensor, an identity for a common object within the respective imaging regions of the imaging sensors; evaluate the determined identities from each of the sensors to determine a configuration for a user interface of the operator assistance system; and generate and output one or more control signals for controlling the user interface in accordance with the determined configuration.

Advantageously the present invention is configured to utilise image data and analysis thereof to determine a configuration for a user interface. In this way, the operator of the agricultural machine is provided with an interface which automatically switches between configurations for different operating conditions, determined or inferred from the data output of the multiple imaging sensors, and specifically an object identification in the data obtained by one or more of the sensors.

The imaging sensors can be of different types. The imaging sensors may be selected from a group comprising: a camera, such as an RGB camera or a greyscale camera, for example, a LIDAR sensor, a RADAR sensor, a thermal imaging camera, and an infra-red (IR) camera. The imaging sensors can additionally or alternatively include one or more of: an image RADAR, a time of flight sensor; and/or an ultrasonic sensor or sensor array, for example.

The control system may be configured to perform an object detection algorithm to determine, from the image data from each imaging sensor, an identity for the object. The object detection algorithm may comprise a trained network for a given sensor type, trained on training images obtained by such sensors in known conditions and labelled for known objects.

For example, the object detection algorithm may comprise a machine-learned model. The machine-learned model may be trained on one or more training datasets with known objects with respective classifications. The machine-learned model may comprise a deep learning model utilising an object detection algorithm. The deep learning model may include a YOLO detection algorithm, such as a YOLOv5 detection model, for example. The training dataset(s) for the model may comprise an agricultural dataset, comprising training images including agricultural-specific objects. Classification by the object detection model may comprise assignment of a class to the object. The class may correspond to an identity for the object for the respective imaging sensor. The class may be one of a plurality of classes for the respective model, as determined during the learning process through assignment of suitable labels to known objects. The plurality of classes may be grouped by category, and optionally by subcategory. For example, the plurality of classes may include ‘tractor’, ‘combine’, ‘car’, ‘truck’, ‘trailer’, ‘baler’, ‘combine header’, ‘square bale’, ‘round bale’, ‘person’, and ‘animal’, for example.

The user interface may comprise a display screen. The display screen may include a display terminal in an operator cab of the machine. The display screen may comprise a screen of a remote user device, such as a smartphone, computer, tablet or the like. In embodiments, the user interface may comprise at least part of an augmented reality system, and could include wearable technology such as smart glasses or the like to provide an augmented image/representation to an operator of the agricultural machine.

Determining the configuration for the user interface may include selecting from a group of possible display configurations in dependence on the determined identities. For example, one or more of the configurations may include a representation of image data obtained by one or more of the imaging sensors. One or more of the configurations for the user interface may comprise a representation of image data obtained by two or more of the imaging sensors. One or more of the configurations may alternatively or additionally include a representation of information obtained or determined from the image data, which may include a label of a distance or determined identity for a given object. This may include an overlay over a representation of images obtained by the sensor(s), such as a text overlay and/or a bounding box or the like highlighting the object within the representation.

The control system may be configured to determine the configuration for the user interface in dependence on an ambient light condition. The ambient light condition may, for example, be inferred from a time of day. An ambient light condition may be determined from sensor data received from a light sensor on or otherwise associated with the agricultural machine. In embodiments, the control system may be configured to select a configuration for the user interface which includes data obtained from a thermal imaging sensor in dependence on a determination of a low ambient light condition, e.g. at dusk/night.

The control system may be configured to compare the determined identities for each of the imaging sensors and determine the user interface configuration in dependence on the comparison. For example, the control system may be configured to determine whether the identities for each of the imaging sensors match. When used here and throughout the specification, the term “match” is intended to cover where the identities are the same—e.g. the determined identities for two or more of the sensors are “tractor”, or “combine”, or “vehicle, or “animal”, etc. The term “match” is also intended to cover where determined identities are variants of one another, e.g. “vehicle” and “tractor”, etc.

The control system may be configured to control generation of a representation of image data from one or more sensors where the determined identities for the object for the one or more sensors match. For example, the control system may be configured to control generation of a representation of image data from a first and/or second sensor where the determined identities for the first and second sensors match. The control system may be configured to control generation of a representation of image data from a first and/or third sensor where the determined identities for the first and third sensors match, but the determined identity for the second sensor is different or does not detect any object, for example.

In embodiments, the imaging sensors comprise a camera, a LIDAR sensor and a thermal camera. In such embodiments, the control system may be configured to control generation of a representation of image data from the LIDAR sensor and the camera in dependence on the determined identities for the object for at least the LIDAR sensor and camera matching. The control system may be configured to control generation of a representation of image data from the LIDAR sensor and the thermal camera in dependence on the determined identities for the object for at least the LIDAR sensor and thermal camera matching. The control system may be configured to control generation of a representation of image data from the LIDAR sensor and the camera in dependence on the determined identities for the object for each of the imaging sensors matching. The control system may be configured to control generation of a representation of image data from the thermal camera only in dependence on an identity for the object being determinable from the data from the thermal camera only. The control system may be configured to control generation of a representation of image data from the LIDAR sensor only in dependence on an identity for the object being determinable from the data from the LIDAR sensor only.

In some instances, objects proximal to the machine may only be present in the field of view of some of the imaging sensors. In such instances, the analysis of the image data from sensor(s) with a field of view which does not include the position of the object may return a null value, e.g. “no object detected”. It could be that the object is in the field of view of a particular sensor but the image data is such that no object can be detected therefrom. This may be due to a faulty sensor, or for example, the operating conditions. For example, it is expected that object detection would be unlikely when utilising an RGB camera at night.

The control system may be configured to control output of a notification or the like indicative of a non-detection or misdetection by one or more of the imaging sensors. This may be where the operating conditions are such that a detection would have been expected (e.g. based on the output of the other imaging sensor(s)), or where analysis of the image data has returned an anomalous identity for the object (again, e.g. with reference to the output of the other imaging sensor(s)). The notification may be provided via the user interface, for example.

The one or more controllers may collectively comprise an input (e.g. an electronic input) for receiving one or more input signals. The one or more input signals may comprise image data from the imaging sensors, for example. The one or more controllers may collectively comprise one or more processors (e.g. electronic processors) operable to execute computer readable instructions for controlling operational of the control system, for example, to analyse the image data, determine the respective object identities and/or evaluate the determined identities for determining the user interface configuration. The one or more processors may be operable to generate one or more control signals for controlling operation of the user interface. The one or more controllers may collectively comprise an output (e.g. an electronic output) for outputting the one or more control signals.

Another aspect of the invention provides an operator assistance system for an agricultural machine, comprising a control system of the preceding aspect of the invention; and a plurality of imaging sensors.

A further aspect of the disclosure provides a method of controlling operation of an operator assistance system for an agricultural machine, comprising: receiving image data from each of a plurality of imaging sensors associated with the agricultural machine, the imaging sensors being configured to image respective imaging regions which at least partly overlap; analysing the image data from each sensor to determine, for each sensor, an identity for a common object within the respective imaging regions of the imaging sensors; evaluating the determined identities from each of the sensors to determine a configuration for a user interface of the operator assistance system; and controlling the user interface in accordance with the determined configuration.

The method may comprise performing one or more operable functions of any component of the control system or system in the manner discussed herein.

In a further aspect there is provided an agricultural machine comprising the control system and/or system of any preceding aspect of the invention, and/or configured to perform the method according to the preceding aspect of the invention.

Optionally, the agricultural machine comprises a combine harvester or a tractor.

A further aspect provides computer software which, when executed by one or more processors, causes performance of a method described herein.

A yet further aspect provides a non-transitory computer readable storage medium comprising computer software described herein.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the disclosure will now be described, by way of example only, with reference to the accompanying drawings, in which:

FIG. 1 is a schematic view of a tractor illustrating aspects of the present disclosure;

FIG. 2 is a schematic illustration of an embodiment of a control system;

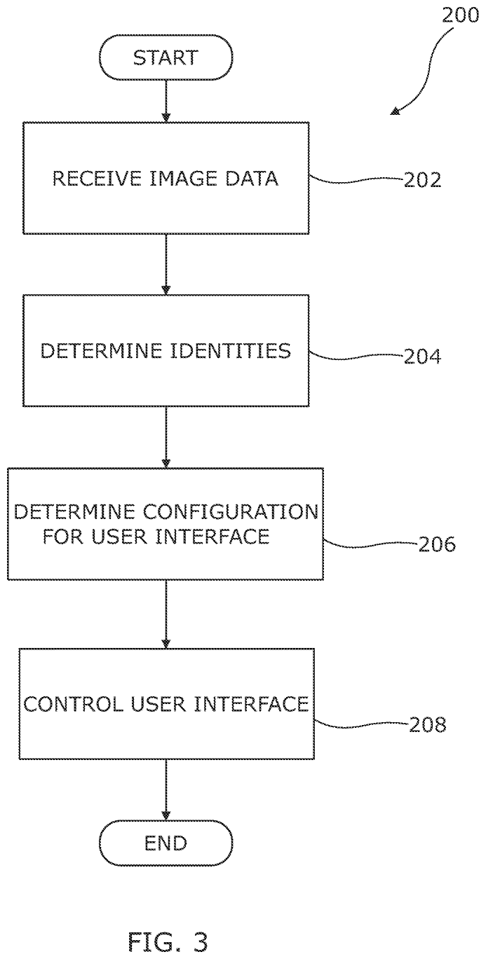

FIG. 3 is a flowchart illustrating an embodiment of a method; and

FIGS. 4A-6 are a series of images illustrating the operational use of embodiments of the present disclosure.

### DETAILED DESCRIPTION

The present disclosure relates in general to a tractor 10, and to a control system 100 and method 200 for controlling operation of one or more components of or associated with the tractor 10, specifically here a user interface, e.g. display terminal 32 provided within an operator cab of the tractor 10. Utilising multiple imaging sensors, e.g. cameras, LIDAR sensors, thermal imaging sensors, etc. and analysing the data obtained therefrom, a configuration for the user interface is determined for increasing the situational awareness for an operator of the combine 10, in particular during low light conditions.

### Tractor

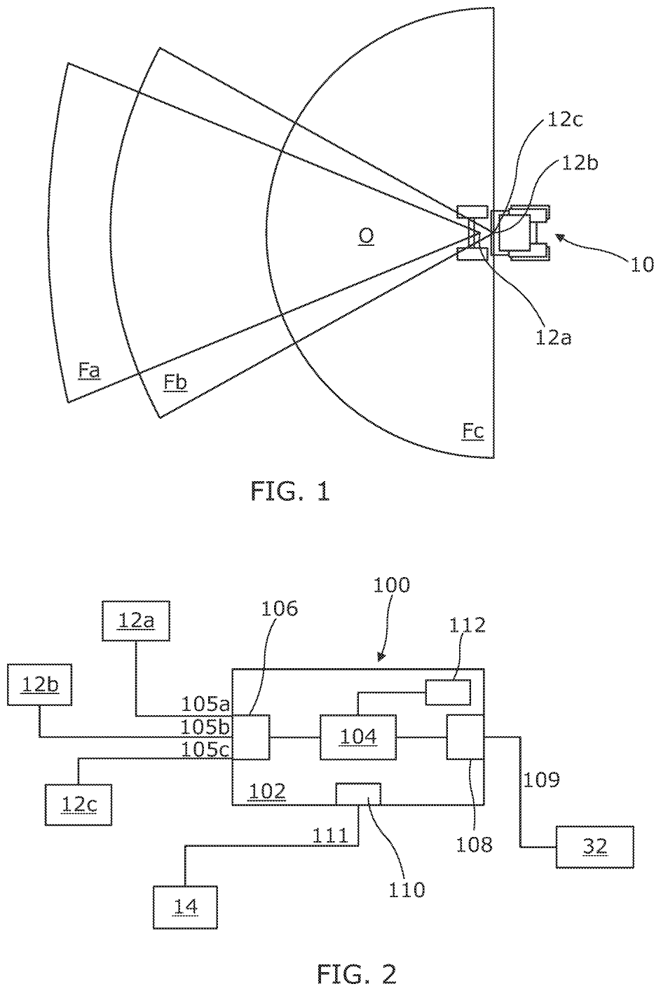

FIG. 1 illustrates an agricultural machine in the form of a tractor 10. Tractor 10 includes, amongst other components, a power unit, wheels and an operator cab as will be appreciated. A user interface in the form of display terminal 32 is provided within the operator cab for providing operational information to an operator of the tractor 10. Imaging sensors in the form of a thermal imaging camera 12a, an RGB camera 12b and a LIDAR sensor 12c are provided and are mounted or otherwise coupled to the tractor 10 and have respective imaging regions Fa, Fb, Fc forward of the tractor 10. It will be appreciated here that the LIDAR sensor 12c at least may have a wider field of view, e.g. up to 360 degrees but only the forward half of the field of view—imaging region Fc—is shown here for clarity. The imaging regions Fa, Fb, Fc partly overlap forming a region O where all three imaging regions overlap.

As described herein, aspects of the present disclosure relate to a control system 100 and associated method 200 for determining a configuration of the display terminal 32 in dependence on image data obtained by each of the imaging sensors 12a, 12b, 12c. Specifically, identities for a common object in the environment of the tractor 10 are determined for each of the imaging sensors 12a, 12b, 12c. It is envisaged that an identity will be determinable for each of the sensors for any object within the overlapping imaging region O, whereas for objects located elsewhere identities may only be determinable for one, some or none of the sensors 12a, 12b, 12c. It may also be possible that an identity may not be determinable for objects within an imaging region of a given sensor due to the object being obscured, or due to a sensor fault, or due to operating conditions, for example, such as low light conditions. As discussed herein, the present invention utilises this to determine a configuration for display terminal 32 to provide enhanced situational awareness for the operator of the tractor 10.

### Control System

The tractor 10 embodies a control system 100 operable to control operation of one or more components of (or associated with) the tractor 10, specifically here display terminal 32 and a configuration thereof in dependence on the determined object identities from one or more of the imaging sensors 12a, 12b, 12c as discussed herein.

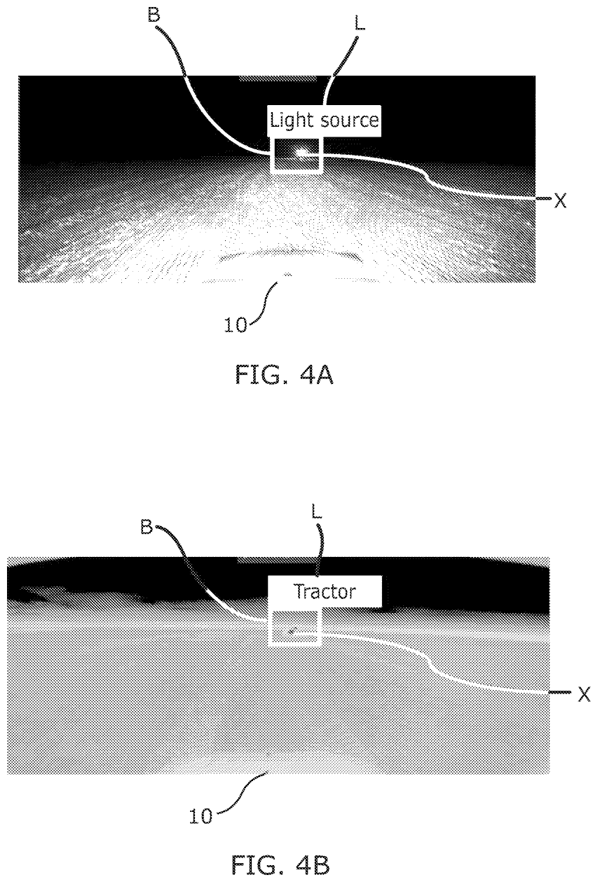

The control system 100 comprises a controller 102 having an electronic processor 104, an electronic inputs 106, 110, an electronic output 108 and memory 112. The processor 104 is operable to access the memory 112 and execute instructions stored therein to perform given functions, specifically to cause performance of the method 200 of FIG. 3 in the manner described hereinbelow, and ultimately generate and output a control signal(s) 109 from output 108 for controlling operation of a display terminal 32 of the tractor 10 following analysis of image data received at electronic inputs 106 from one or more of the imaging sensors 12a, 12b, 12c and optionally sensor data received at input 110, e.g. from an ambient light sensor 14.

Here, the processor 104 is operable to receive signals from imaging sensors 12a, 12b, 12c, where the signals comprise image data from the sensors 12a, 12b, 12c indicative of an environment about the tractor 10. In this illustrated embodiment, the image data includes data indicative of respective imaging regions Fa, Fb, Fc of the sensors 12a, 12b, 12c, including in the overlapping region O. The signals from the sensors are in the form of respective input signals 105a, 105b, 105c received at electronic input 106 of controller 102. Control signals 109 are output via electronic output 108 to display terminal 32, and specifically to a control unit thereof for configuring the display terminal 32 and any imagery displayed thereby in accordance with a configuration as determined as described herein.

### Method

An embodiment of a method 200 is illustrated by FIG. 3.

At step 202, image data is received from each of the imaging sensors, which in the illustrated embodiment comprises a thermal imaging camera 12a, an RGB camera 12b and a LIDAR sensor 12c. As discussed herein, the image data includes data indicative of respective imaging regions Fa, Fb, Fc of the sensors 12a, 12b, 12c, those imaging regions at least partly overlapping, e.g. in the manner shown in FIG. 1.

The image data received from each of the sensors 12a, 12b, 12c is then analysed to determine, for each of the sensors 12a, 12b, 12c an identity for a common object within the environment of the tractor 10 (step 204). This analysis comprises, for the image data received from each sensor 12a, 12b, 12c performance of an object detection algorithm for detecting the presence of an object within the image data and, if possible, determine an identity for the object.

In practice, the object detection algorithm may take any one of a number of different forms, but can include utilising a trained model for the given sensor type trained on reference data obtained in known operating conditions and for known object types. The output for each sensor 12a, 12b, 12c may be a classification for the common object and optionally a confidence value for the classification, as determined as part of the object detection process. The classification may include, for example, a “vehicle”, “animal”, “boundary” and/or “other” classification. This could, in practice, extend to sub-classifications where the models utilised are trained to such an extent, with it being plausible that the sensor data could be analysed to distinguish between different vehicle types, between animals and humans, and/or between different boundary types—e.g. “hedgerow” or “wall”. In addition, the sensor data from LIDAR sensor 12c may additionally provide depth information for the object, specifically a distance between the object and the tractor 10.

As discussed herein, where an object is present in the overlapping region, O, it is envisaged that an identity may be determined for each of the sensors 12a, 12b, 12c. However, where no determination is able to be made for any given sensor, an appropriate output may be provided indicating such—e.g. “no object detected”.

In step 206, the identities determined for each sensor 12a, 12b, 12c are evaluated to determine a configuration for the display terminal 32. Specifically, step 206 comprises comparing the determined identities for each sensor type to confirm which, if any, match one another and then determine a configuration for the display terminal 32 which utilises this information. As discussed herein, the term “match” is intended to cover where the identities are the same and/or where the determined identities are variants of one another. The configuration for the display terminal 32 is determined which, in general, includes a representation of image data from at least one of the “matching” sensors 12a, 12b, 12c, or a default configuration as discussed hereinbelow. As a result, multiple configurations for the display terminal are possible, each providing an operator with enhanced situational awareness whilst performing a given task.

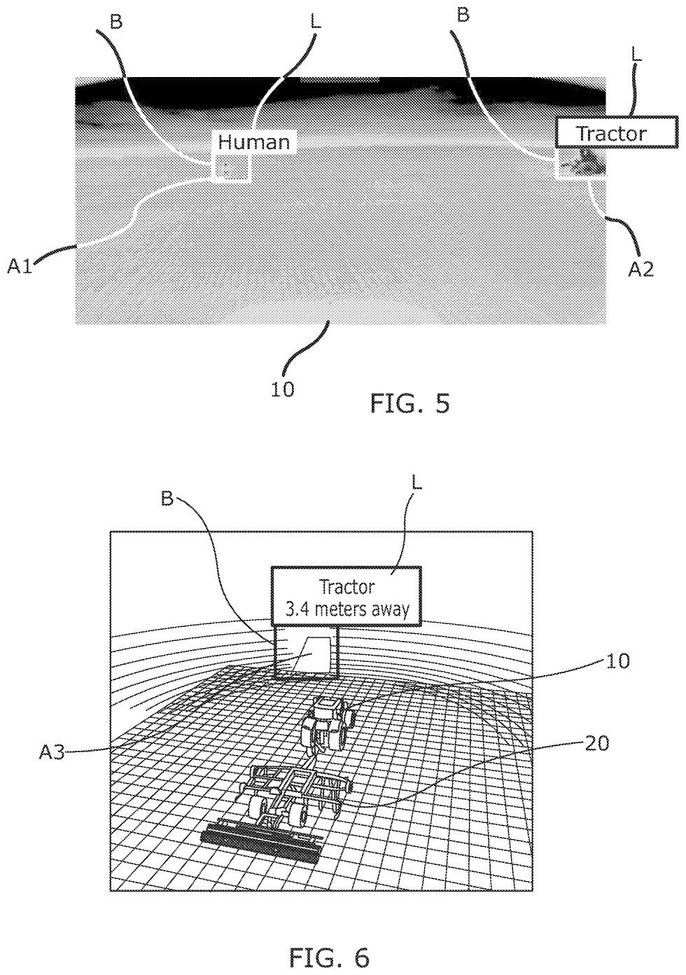

Examples of specific configurations are shown in FIGS. 4A-6 and are discussed in detail below, but may include, for example, a representation of an image obtained by the relevant sensor(s) 12a, 12b, 12c and/or additional information extracted from such sensor data including, for example, a distance measurement to an object determined from the data received from LIDAR sensor 12c. Additional indicia may also be included on the image provided by the display terminal 32, which may include for example bounding boxes and/or object labels or other means to highlight, within the representation shown, the position and determined identities of object(s).

A first configuration for the display terminal 32 includes a representation of image data from the LIDAR sensor 12c and the RGB camera 12b in dependence on the determined identities for the object for at least the LIDAR sensor 12c and the RGB camera 12b matching. This can include the image obtained by the RGB camera 12b overlaid with further information determined from the LIDAR sensor data, e.g. a distance.

A second configuration for the display terminal 32 includes a representation of image data from the LIDAR sensor 12c and the thermal camera 12a in dependence on the determined identities for the object for at least the LIDAR sensor 12c and thermal imaging camera 12a matching. Similarly, this can include the image obtained by the thermal imaging camera 12a overlaid with further information determined from the LIDAR sensor data, e.g. a distance.

A further configuration for the display terminal 32 may include a representation of image data from the LIDAR sensor 12c and the RGB camera 12b in dependence on the determined identities for the object for all three of the imaging sensors matching. Again, this can include the image obtained by the RGB camera 12b overlaid with further information determined from the LIDAR sensor data, e.g. a distance.

A yet further configuration for the display terminal may include a representation of image data from the thermal imaging camera 12a only in dependence on an identity for the object being determinable from the data from the thermal imaging camera 12a only.

A further configuration for the display terminal 32 may include a representation of image data from the LIDAR sensor 12c only in dependence on an identity for the object being determinable from the data from the LIDAR sensor 12c only.

A further configuration for the display terminal 32 may include a representation of image data from the RGB camera 12b only in dependence on an identity for the object being determinable from the data from the RGB camera 12b only.

Where none of the determined identities match, or where no identity is determined for any of the sensors, a default configuration for the display terminal 32 may be determined. This may include generation of a representation for the image data obtained by any one or more of the sensors 12a, 12b, 12c which may be predefined and/or may be user definable. For example, this may include always displaying a representation of the image obtained by the RGB camera where no detection of an object is possible.

In an extension of the illustrated embodiment, sensor data from ambient light sensor 14 may be utilised to determine the configuration for the display terminal 32. For example, where low light conditions are determined a configuration for the display terminal 32 may be determine which incorporates a representation of image data obtained by the thermal imaging camera 12a either solely or in combination with data obtained by the RGB camera and/or LIDAR sensor.

### EXAMPLES

Example display terminal configurations are provided in FIGS. 4A-6.

FIGS. 4A and 4B illustrate how appropriate selection of a configuration for the display terminal 32 can advantageously improve situational awareness for an operator of the tractor 10. FIG. 4A illustrates a first configuration wherein a representation of the image data obtained by camera 12b is provided with a bounding box B and label L highlighting and identifying the object X in the image. Due to a low ambient light condition, e.g. as determined by ambient light sensor 14, the image obtained by camera 12b and the identity for the object X as determined by analysis of the camera 12b image data is not clear for an operator. For example, in this configuration, an identity of “Light source” has been determined for the object X which may not be useful for the operator.

FIG. 4B illustrates a configuration for the display terminal 32 as determined utilising the control system 100 employing the method 200 described herein. Specifically, a representation of image data obtained by thermal imaging camera 12a is provided, again with bounding box B, label L highlighting and identifying object X in the image. However, in this instance it has been determined that the object is a tractor and a suitable label has been provided. As discussed herein, this can include determining this configuration in dependence on the determined identities for the thermal imaging camera 12a and the LIDAR sensor 12c matching in some manner, or where a low ambient light condition has been identified from the determined identity from the thermal imaging camera 12a only. In either case, it can be seen that the configuration provided in FIG. 4B provides an increased situational awareness for an operator of the tractor 10 when compared with the configuration provided in FIG. 4A.

FIG. 5 provides an example configuration for the display terminal 32 showing how multiple different objects A1, A2 may be identifiable in the image data from the sensor(s) 12a, 12b, 12c. In this specific example, the control system 100 has determined a configuration for the display terminal 32 which includes a representation of image data obtained from the thermal imaging camera 12b, with bounding boxes B and respective labels L, provided for objects A1, A2. Here, the objects A1, A2 have been identified as a human and as a tractor.

FIG. 6 illustrates a yet further example configuration for the display terminal 32. In this instance, the control system 100 has determined a configuration for the display terminal 32 which includes a representation of image data obtained by LIDAR sensor 12c. As discussed herein, this may be due to an identity for the object X only being determinable from the data from the LIDAR sensor 12c. The illustrated representation includes a virtual perspective view of the tractor 10, here towing implement 20 with object A3 within the environment of the tractor 10. A bounding box B and label L is provided, here positively identifying a further tractor (object A3) within the environment, but also giving an indication of the distance between the tractor 10 and the object A3.

### General

In a variant, the user interface may, in addition or as an alternative to the display terminal 32, comprise a remote user device such as a smartphone, tablet computer, etc. carried by an operator of the tractor 10 and configured for use with the tractor 10 in the same manner as an integrated display terminal, such as display terminal 32.

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as set out herein and a machine readable storage storing such a program. Still further, embodiments of the present invention may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

1. A control system for an operator assistance system for an agricultural machine, the control system comprising one or more controllers, and being configured to:
receive image data from each of a plurality of imaging sensors associated with the agricultural machine, the imaging sensors being configured to image respective imaging regions which at least partly overlap;
analyze the image data from each sensor to determine, for each sensor, an identity for a common object within the respective imaging regions of the imaging sensors;
evaluate the determined identities from each of the sensors to determine a configuration for a user interface of the operator assistance system; and
generate and output one or more control signals for controlling the user interface in accordance with the determined configuration.

2. A control system as claimed in claim 1, wherein each of the imaging sensors are selected from a group comprising: a camera, a LIDAR sensor, a RADAR sensor, a thermal imaging camera, and an infra-red (IR) camera.

3. A control system of claim 1, configured to perform an object detection algorithm to determine, from the image data from each imaging sensor, an identity for the object.

4. A control system as claimed in claim 1, wherein the user interface comprises a display screen.

5. A control system as claimed in claim 4, wherein the display screen comprises:
a display terminal in an operator cab of the machine; and/or a screen of a remote user device.

6. A control system as claimed in claim 1, wherein determining the configuration for the user interface comprises selecting from a group of possible display configurations in dependence on the determined identities.

7. A control system as claimed in claim 6, wherein each of the configurations for the user interface comprises a representation of image data obtained by one or more of the imaging sensors.

8. A control system as claimed in claim 6 or claim 7, wherein one or more of the configurations for the user interface comprises a representation of image data obtained by two or more of the imaging sensors.

9. A control system of claim 6, configured to determine the configuration for the user interface in dependence on an ambient light condition.

10. A control system as claimed in claim 9, wherein the ambient light condition is inferred from a time of day; and/or wherein an ambient light condition is determined from sensor data received from a light sensor on or otherwise associated with the agricultural machine.

11. A control system of claim 6, configured to compare the determined identities for each of the imaging sensors and determine the user interface configuration in dependence on the comparison.

12. A control system of claim 6, wherein the imaging sensors comprise a camera, a LIDAR sensor and a thermal camera.

13. A control system of claim 12, configured to control generation of a representation of image data from the LIDAR sensor and the camera in dependence on the determined identities for the object for at least the LIDAR sensor and camera matching.

14. A control system of claim 12, configured to control generation of a representation of image data from the LIDAR sensor and the thermal camera in dependence on the determined identities for the object for at least the LIDAR sensor and thermal camera matching.

15. A control system of claim 12, configured to control generation of a representation of image data from the LIDAR sensor and the camera in dependence on the determined identities for the object for each of the imaging sensors matching.

16. A control system of claim 12, configured to control generation of a representation of image data from the thermal camera only in dependence on an identity for the object being determinable from the data from the thermal camera only.

17. A control system of claim 12, configured to control generation of a representation of image data from the LIDAR sensor only in dependence on an identity for the object being determinable from the data from the LIDAR sensor only.

18. An operator assistance system for an agricultural machine, comprising the control system of any preceding claim and a plurality of imaging sensors.

19. An agricultural vehicle comprising or being controllable by the control system of claim 18.

20. A method of controlling operation of an operator assistance system for an agricultural machine, comprising:
receiving image data from each of a plurality of imaging sensors associated with the agricultural machine, the imaging sensors being configured to image respective imaging regions which at least partly overlap;
analyzing the image data from each sensor to determine, for each sensor, an identity for a common object within the respective imaging regions of the imaging sensors;
evaluating the determined identities from each of the sensors to determine a configuration for a user interface of the operator assistance system; and
controlling the user interface in accordance with the determined configuration.
